(19) United States
(12) Patent Application Publication
(10) Pub. No.: US 2018/0349065 A1
(43) Pub. Date: Dec. 6, 2018

(54) PROGRAM SETTING SYSTEM, PROGRAM SETTING METHOD, AND ELECTRONIC DEVICE

(71) Applicant: YUSUKE HAYASHI, Kanagawa (JP)

(72) Inventor: YUSUKE HAYASHI, Kanagawa (JP)

(73) Assignee: Ricoh Company, Ltd., Tokyo (JP)

(21) Appl. No.: 15/991,219

(22) Filed: May 29, 2018

(30) Foreign Application Priority Data
Jun. 1, 2017 (JP) 2017-109502

(51) Int. Cl. G06F 3/12; G06F 21/10

(52) U.S. Cl. CPC G06F 3/123; G06F 3/1293; G06F 21/105; G06F 3/1231

(57) ABSTRACT

A program setting system includes a first electronic device communicable with one or more servers including an application server and a second electronic device communicable with the one or more servers. The first electronic device includes first circuitry to transmit, to the one or more servers, identification information of the first electronic device and program identification information for identifying a program operating in the first electronic device. The second electronic device includes second circuitry to receive, from the one or more servers, the program identification information identified by the identification information of the first electronic device; acquire the program identified by the program identification information from the application server; and install the acquired program in the second electronic device.

### CROSS-REFERENCE TO RELATED APPLICATION

This patent application is based on and claims priority pursuant to 35 U.S.C. § 119(a) to Japanese Patent Application No. 2017-109502, filed on Jun. 1, 2017 in the Japan Patent Office, the entire disclosure of which is hereby incorporated by reference herein.

### BACKGROUND

### Technical Field

Embodiments of the present disclosure relate to a program setting system, a program setting method, and an electronic device.

### Background Art

In electronic devices such as printers used in offices, programs called various applications are operating. The type of application operating varies depending on an electronic device and a user. There are various types of application to be operated, for example, an application that recognizes or translates characters of image data of a scanned document.

### SUMMARY

In one aspect of this disclosure, there is provided an improved program setting system includes a first electronic device communicable with one or more servers including an application server and a second electronic device communicable with the one or more servers. The first electronic device includes first circuitry to transmit, to the one or more servers, identification information of the first electronic device and program identification information for identifying a program operating in the first electronic device. The second electronic device includes second circuitry to receive, from the one or more servers, the program identification information identified by the identification information of the first electronic device; acquire the program identified by the program identification information from the application server; and install the acquired program in the second electronic device.

In another aspect of this disclosure, there is provided an improved program setting method including receiving program identification information for identifying a program operated in a first electronic device, by a second electronic device, from one or more servers communicable with the first electronic device and the second electronic device. The program identification information has been transmitted from the first electronic device to the one or more servers with identification information of the first electronic device. The program setting device further includes acquiring the program identified by the program identification information from an application server of the one or more servers; and installing the identified program in the second electronic device.

In still another aspect of this disclosure, there is provided an improved electronic device comprising circuitry to receive program identification information for identifying a program operated in another electronic device, by the electronic device, from one or more servers communicable with the electronic device and said another electronic device. The program identification information has been transmitted from said another electronic device to the one or more servers with identification information of said another electronic device. The circuitry is further configured to acquire the program identified by the program identification information from an application server of the one or more servers; and install the identified program in the electronic device.

### BRIEF DESCRIPTION OF THE DRAWINGS

The aforementioned and other aspects, features, and advantages of the present disclosure will be better understood by reference to the following detailed description when considered in connection with the accompanying drawings, wherein:

FIG. 1 is an illustration of an operation example of a program setting system according to an embodiment of the present disclosure;

FIG. 2 is an illustration of a schematic configuration of the program setting system in FIG. 1;

FIG. 3 is a schematic diagram of a hardware configuration of an electronic device according to an embodiment of the present disclosure;

FIG. 4 is a block diagram of an example hardware configuration of a backup server according to an embodiment of the present disclosure;

FIG. 5 is a block diagram of an example functional configuration of the electronic device of FIG. 3, the backup server of FIG. 4, an activation server, and an application server, which are included in the program setting system in FIG. 1;

FIG. 6 is a sequence diagram of a process for storing setting data of the application in the backup server, performed by a customer engineer (CE), according to an embodiment of the present disclosure;

FIG. 7 is an illustration of an example of a backup operation screen according to an embodiment of the present disclosure;

FIGS. 8A and 8B are illustrations of a flowchart of a process performed by the activation server;

FIG. 9 is a sequence diagram of an example of a process for storing setting data of an application to the electronic device, performed by the CE;

FIG. 10 is an illustration of an operation process, performed by the activation server;

FIGS. 11A and 11B are illustrations of a flowchart of another process, performed by the activation server;

FIG. 12 is a sequence diagram of a process for installing the application, performed by the electronic device;

FIG. 13 is a sequence diagram of a process for determining whether to boot the application according to the presence or absence of activation;

FIG. 14A is a sequence diagram of a process for exporting setting data according to an embodiment of the present disclosure; and

FIG. 14B is a sequence diagram of a process for importing setting data according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that have the same function, operate in a similar manner, and achieve similar results.

Although the embodiments are described with technical limitations with reference to the attached drawings, such description is not intended to limit the scope of the disclosure and all of the components or elements described in the embodiments of this disclosure are not necessarily indispensable.

A description is given of a program setting system and a program setting method according to embodiments of the present disclosure, referring to the figures.

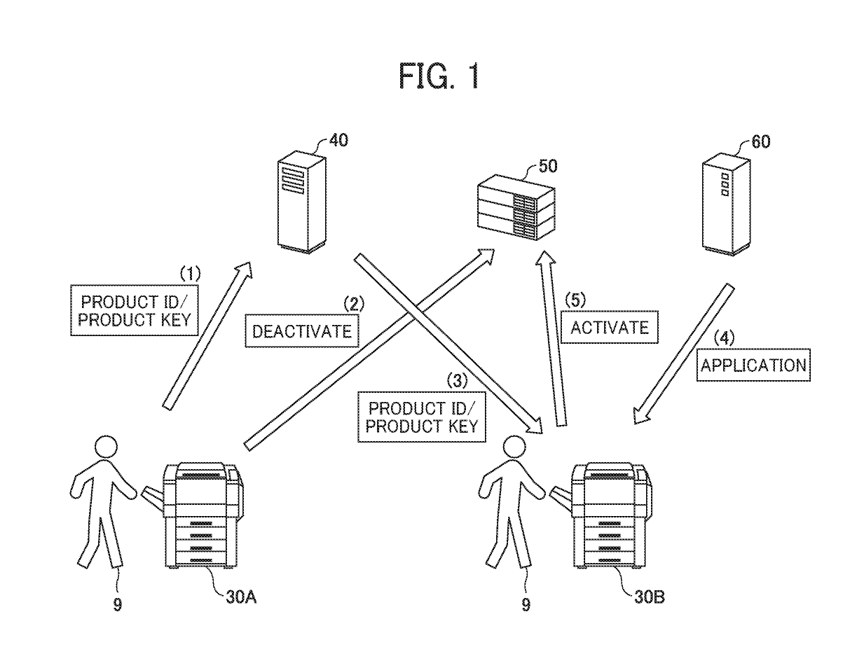

FIG. 1 is an illustration of an operation example of a program setting system 100 according to an embodiment of the present disclosure. In the following, the outline of the operation is described. For the descriptive purposes, it is assumed that an electronic device 30A is to be updated into an electronic device 30B.

(1) A customer engineer (CE) 9 operates the electronic device 30A before update and stores a product identification (ID) and a product key of an application installed or used in the electronic device 30A together with setting data of the electronic device 30A in a backup server 40. The product ID is an example of identification information for identifying an application distributed to a user for use in, for example, the electronic device 30A. The product key is an example of individual license information that certifies that a user is authorized to use such application.

(2) The CE 9 requests the activation server 50 to deactivate the application. The term “deactivate” refers to registering that an application is not being used. Such a deactivation enables the application to be used in a different electronic device 30B while disabling the application to be used in the electronic device 30A.

(3) Next, the CE 9 operates the updated electronic device 30B to acquire the setting data, product ID, and product key from the backup server 40, for storage in the updated electronic device 30B.

(4) The CE 9 further downloads the application identified by the product ID from an application server 60 to the updated electronic device 30B.

(5) Then, the CE 9 requests the activation server 50 to activate the downloaded application, using the product ID and the product key. The term “activation” refers to a state in which the user is authorized to use an application. That is, the CE 9 continuously uses the application used in the electronic device 30A, in the electronic device 30B by requesting the activation server 50 to activate the application after deactivation of the application. The electronic device 30B configures the activated application with the setting data.

In that way, using the deactivation and activation mechanism, the CE 9 can use the application in the updated electronic device 30B without backing up the application in updating the electronic device 30. Accordingly, such a configuration prevents use of a large volume of data for backing up the application while reducing a time required for backing up the application.

Note that there is no need to customize program, which is being executed in an electronic device, with a change in setting data to be exported in the present embodiment of the present disclosure. Further, examples of the program include an operating system (OS), firmware, and a device driver, in addition to application.

The setting data is various kinds of information to be set or used in the program. Alternatively, the setting data is information to be set from an external device of the electronic device to change the operation of the program. Although the setting data is used by the program in some senses, the setting data may not be related to the program. Table 1 indicates a specific example of the setting data.

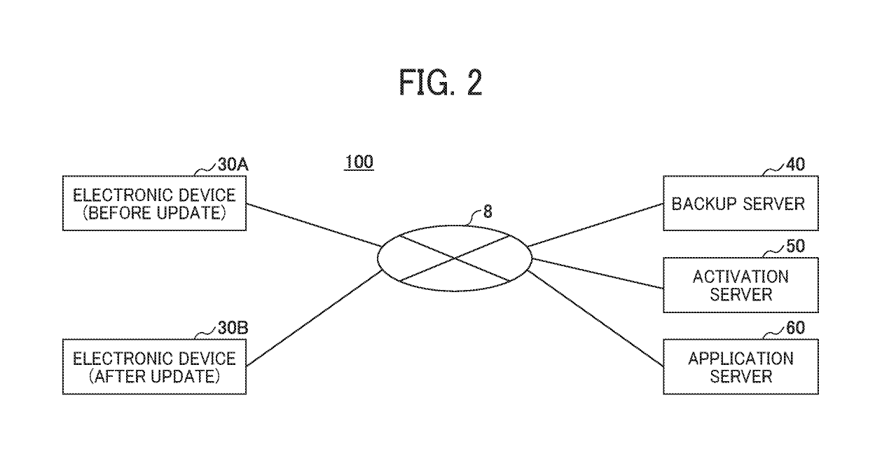

FIG. 2 is a schematic diagram of the configuration of a program setting system 1000. The program setting system 1000 includes at least two electronic devices 30A and 30B, a backup server 40, an activation server 50, and an application server 60, which are communicable with each other via network 8. Hereinafter, any of a plurality of electronic devices 30A and 30B is referred to as an electronic apparatus 30.

The network 8 is built, for example, with a local area network (LAN) set in an institution or the like where the electronic devices 30A and 30B are set, a provider network provided by a provider that connects the LAN to the Internet, or a line provided by a carrier. When the network 8 includes a plurality of LANs, it is called a wide area network (WAN). In some case, the network 8 is implemented by LAN or a wide area Ethernet (registered trademark) without including WAN or the Internet. The network 8 is configured as one or both of a wired network and a wireless network. Additionally, the electronic devices 30A and 30B connect to the provider network without using the LAN, to directly connect to a public line network.

The electronic device 30A is set with the setting data for controlling operation of one or more applications to be operated on the electronic device 30A. The electronic device 30B reuses such setting data. In the present embodiment, the electronic device 30A corresponds to an old device 30 that is to be replaced with a new electronic device 30B in a company.

The electronic device 30B corresponds to the new device 30 in which the same application is installed and the setting data is reused. The electronic device 30A (first electronic device) stores the setting data in the backup server 40, and the electronic device 30 B (second electronic device) obtains setting data from the backup server 40.

Examples of the electronic device 30A include a multifunction peripheral (MFP), a projector, an electronic whiteboard, and a videoconference terminal. The multifunction peripheral is referred to as, for example, a MFP, a copier, an image forming apparatus, an image processing apparatus, or a printer. In some cases, the projector is referred to as a projecting apparatus.

In some cases, the electronic whiteboard is referred to as, for example, an electronic information board. Additionally, in some examples, the electronic device 30 is a digital signage, a digital camera, or a drone. The electronic device 30 is any device that operates according to any application, with the setting data that can be reused.

The backup server 40 is an information processing device that stores setting data, a product ID, and a product key transmitted from the electronic device 30A. Such storing in the backup server 40 may be referred to as, for example, export, backup, or upload. Further, the backup server 40 transmits the setting data, product ID, and product key to the electronic device 30B. Introducing the setting data, product ID and product key from the backup server 40 to a new electronic device, i.e, the electronic device 30B is referred to as, for example, import, restore, or download.

The activation server 50 is an information processing device that activates and deactivates applications. When the activation server 59 determines that the application is authenticated using the product key, the application operates in the electronic device 30.

The term “activation” refers to, for example, activating an application, i.e., making an application active, or valid. On the contrary, the term “deactivation” refers to, for example, deactivating an application, i.e., making an application inactive or invalid.

The application server 60 is an information processing device that registers therein various types of applications, which may be executed by the electronic device 30, and distributes the applications to the electronic device 30. Alternatively, the application is distributed as data stored in a portable storage medium. In this case, the application server 60 is not used. The portable storage medium is, for example, a secure digital (SD) card (registered trademark), a universal serial bus (USB) memory, a compact flash (registered trademark), a multimedia card, a floppy, a memory stick (registered trademark), or a hard disk drive externally connected.

In some embodiments, one or more of the backup server 40, the activation server 50, and the application server 60 are adapted to cloud computing. The term “cloud computing” refers to Internet-based computing where the resources in the network are used or accessed without identifying specific hardware resources.

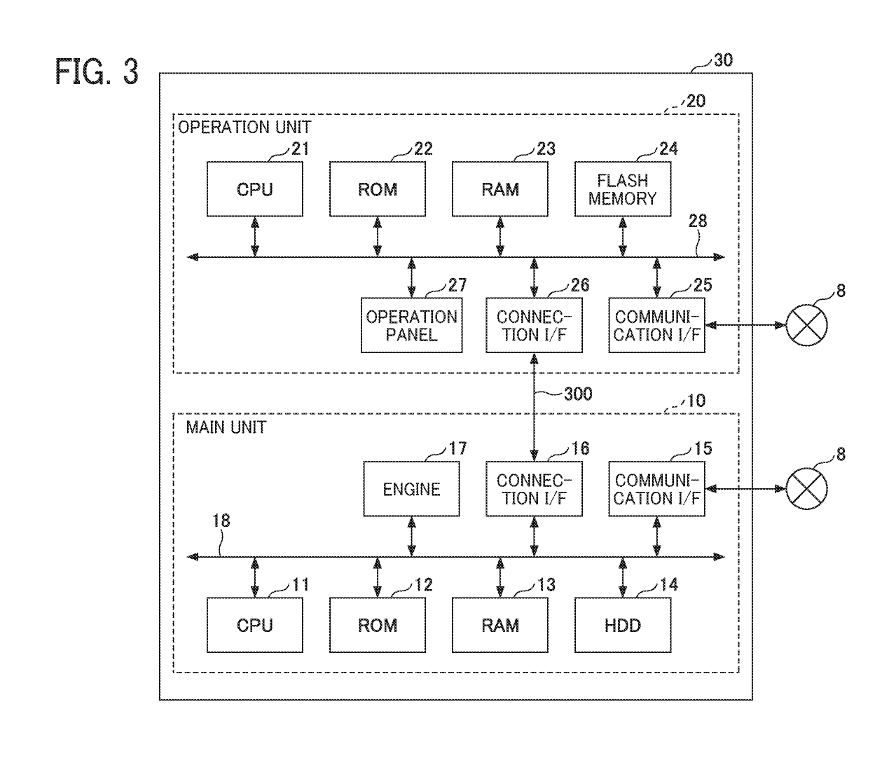

FIG. 3 is a schematic diagram of a hardware configuration of the electronic device 30 according to an embodiment of the present disclosure. The electronic device 30 in FIG. 3 is assumed to be a MFP. As illustrated in FIG. 3, the electronic device 30 includes, for example, a main unit 10 and an operation unit 20. The main unit 10 and the operation unit 20 are communicably connected to each other via a dedicated communication path 300. A communication path compatible with Universal Serial Bus (USB) standard is used as an example of the communication path 300. Alternatively, any wireless or wired communication path is used as the communication path.

Note that the main unit 10 performs an operation in accordance with a user operation accepted by the operation unit 20. The main unit 10 is also capable of communicating with an external apparatus such as a client personal computer (PC) and operating in response to an instruction received from the external apparatus.

A hardware configuration of the main unit 10 is described below. As illustrated in FIG. 3, the main unit 10 includes a central processing unit (CPU) 11, a read-only memory (ROM) 12, a random access memory (RAM) 13, a hard disk drive (HDD) 14, a communication interface (I/F) 15, a connection I/F 16, and an engine 17, which are communicably connected with each other via the system bus 18. In FIG. 3, the description where the main unit 10 includes the HDD 14 is given as an example. However, in some examples, a configuration without the HDD 14 and a sufficient storage area is applicable.

The CPU 11 controls the entire operation of the main unit 10. The CPU 11 controls the entire operation of the main unit 10 by executing a program stored in the ROM 12 and the HDD 14 using the RAM 13 as a work area and implements various functions such as the copy function, scan function, facsimile function, and print function.

The communication I/F 15 as a network interface is an interface for connecting the main unit 10 with the network 8. The connection I/F 16 is an interface for allowing the main unit 10 to communicate with the operation unit 20 via the communication path 300.

The engine 17 is hardware that performs processing other than general-purpose information processing and communications. For example, the engine 17 implements a copier function, a scanner function, a facsimile function, and a printer function. The engine 17 includes, for example, a scanner (image scanner) that scans and reads an image of a document, a plotter (image forming unit) that performs printing on a sheet material such as paper, and a facsimile unit that performs facsimile communication. In some examples, the engine 17 further includes optional equipment such as a finisher that applies finishing processing including sorting the printed sheets, and an automatic document feeder (ADF) that automatically feeds documents to be scanned.

A hardware configuration of the operation unit 20 is described below. As illustrated in FIG. 3, the operation unit 20 includes a CPU 21, a ROM 22, a RAM 23, a flash memory 24, a communication I/F 25, a connection I/F 26, and an operation panel 27, which are communicable with each other via a system bus 28. In FIG. 3, the description where the operation unit 20 includes a flash memory 24 as an example. However, in some examples, a configuration without the flash memory 14 is applicable. In other word, in some examples, the electronic device has a configuration without a storage device to store received contents.

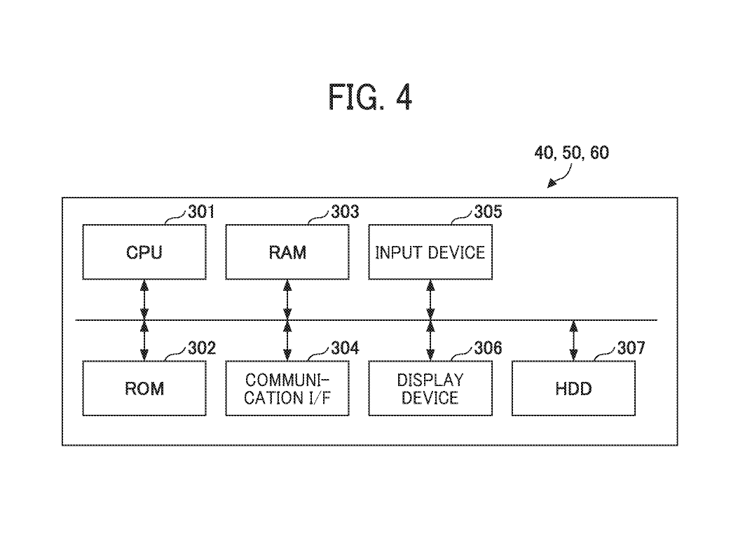

FIG. 4 is a block diagram of an example hardware configuration of the backup server 40. In the following, a description is given of the backup server 40. The backup server 40 includes a CPU 301, a ROM 302, a RAM 303, a communication I/F 304, an input device 305, and a display device 306.

The CPU 301 controls the entire operation of the backup server 40.

The ROM 302 is a nonvolatile memory that stores various data such as programs.

The RAM 303 is a volatile memory that functions as a work area where the CPU 301 performs various operations.

The communication I/F 304 is an interface for connecting the main unit 10 with the network 8.

The input device 305 is a device used for inputting operations by the user, and is configured with, for example, a mouse, and a keyboard.

The display device 306 is a device for displaying various information, and is, for example, a liquid crystal display.

The hardware configuration of each of the activation server 50 and the application server 60 may be the same as or different from that of the backup server 40.

In some examples, the backup server 40 does not have the hardware configuration that is housed in one housing and provided as apparatus of one unit as illustrated in FIG. 4. The hardware configuration indicates hardware elements included in the backup server 40.

Further, in some examples, a physical configuration of the backup server 40 in the present example is not static to support the cloud computing. Thus, hardware resources are dynamically connected/disconnected according to load to constitute the backup server 40.

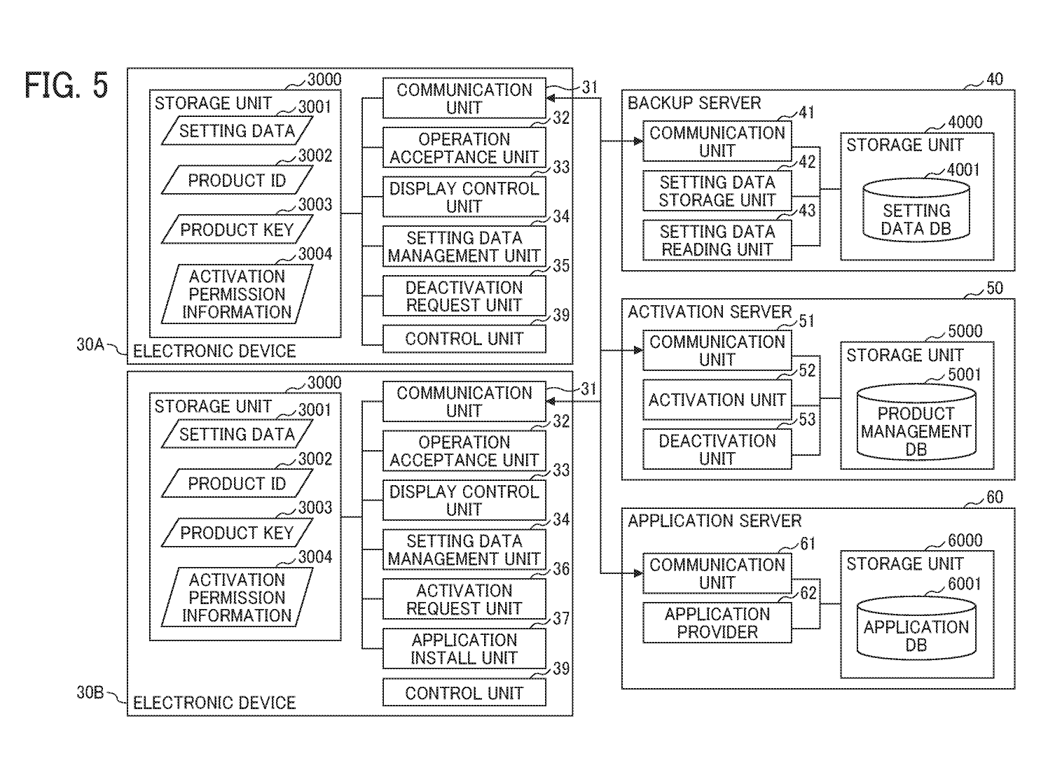

Next, a description is given below of a functional configuration of the program setting system 100, referring to FIG. 5. FIG. 5 is a block diagram of an example functional configuration of the electronic device 30, the backup server 40, the activation server 50, and the application server 60, which are included in the program setting system 100.

The electronic devices 30A and 30B, which are separately illustrated in FIG. 5, have the common functions.

The electronic device 30A includes a communication unit 31, an operation acceptance unit 32, a display control unit 33, a setting data management unit 34, a deactivation request unit 35, and a control unit 39.

As described above, the electronic device 30 (the electronic device 30A and the electronic device 30B) has the main unit 10 and the operation unit 20. Any one of functions illustrated in FIG. 5 may be achieved by either the main unit 10 or the operation unit 20. In one example, the main unit 10 includes the communication unit 31 and the operation unit 20 includes the other functions (the other units other than the communication unit 31 in FIG. 5).

These functional units of the electronic device 30A are implemented by operating some of the hardware elements in FIG. 3 under the control of the CPU 11 and 21 in accordance with program expanded from the HDD 13 to the RAM 13 or program expanded from the flash memory 24 to the RAM 23.

The program is distributed from a server for program distribution, or is distributed in a state where the program is stored in a storage medium.

The communication unit 31 exchanges various data with the backup server 40, the activation server 50, and the application server 60 via the network 8. The communication unit 31 is implemented by, for example, the CPU 11 in FIG. 3 executing the program to control the communication I/F 15.

The operation acceptance unit 32 accepts various operations for the electronic device 30 from the CE 9 or the user. The operation acceptance unit 32 is implemented by, for example, the CPU 21 of FIG. 3 executing a program to control the operation panel 27.

The display control unit 33 displays various screens generated by applications, in the operation panel 27. In the present embodiment, the display control unit 33 displays a backup operation screen and an introduction operation screen for selecting a mode between a mode for updating and a mode for adding the electronic device 30 are displayed on the operation panel 27.

The setting data management unit 34 manages setting data. For example, the setting data management unit 34 obtains user setting for an application and stores the user setting as the setting data in a storage unit 3000, or reads setting data from the storage unit 300.

The setting data is to be described later, referring to Table 1. The setting data management unit 34 is implemented by, for example, the CPU 21 of FIG. 3 executing a program.

The deactivation request unit 35 requests the activation server 50 to deactivate an application. The deactivation request unit 35 is implemented by, for example, the CPU 21 of FIG. 3 executing a program.

The control unit 39 performs control regarding booting of the application. More specifically, the control unit 39 determines whether it is permitted to boot the application or not referring to the activation permission information 3004. When it is not permitted to boot the application (a negative determination is made), the control unit 39 notifies the user of the need for activation. The control unit 39 is implemented by, for example, the CPU 21 of FIG. 3 executing a program.

The electronic decide 30A includes a storage unit 3000. The storage unit 3000 is implemented using one or more of the flash memory 24, the RAM 23, the ROM 22, the HDD 14, the RAM 13, and the ROM 12 in FIG. 3.

The storage unit 3000 stores setting data 3001, a product ID 3002, a product key 3003, and activation permission information 3004.

TABLE 1
A. Address Book
For example: Information associated with user names, telephone numbers,
FAX number, and E-mail addresses
B. Printing Position of Header/Footer
For example: Printing positions of page numbers and dates
C. Energy-Saving Setting Value
For example: Length of time to change to energy-saving mode
D. Debug Setting Value
For example: Debug log in an electronic device, made in occurrence of
an event
E. Setting Value for Sequence for Feeding Trays
For example: Setting value for designating the sequence of a feeding
tray to be preferentially used for feeding a sheet

Table 1 indicates an example of the setting data 3001. The specific content of the setting data 3001 varies depending on the application, and there may be setting data commonly used by a plurality of applications. Further, there may be setting data for operating the electronic device 30 irrespective of the application.

In Table 1-A, common setting data is set for a plurality of applications. Table 1-B indicates setting data for a print application. Table 1-C indicates setting data for operating the electronic device 30. Table 1-D indicates setting data for the application or the operation of the electronic device 30. Table 1-E indicates setting data common between a print application and a copy application.

TABLE 2

| | |
|---|---|
| Product ID | 001 |

Table 2 indicates an example of a product ID 3002. The product ID 3002 is identification information for identifying an application distributed to the user. Different electronic devices 30, to which the same application has been distributed, have the common product ID 3002. The product ID allows the type of application to be identified.

The “ID” refers to an identifier or identification information. The ID is a name, a symbol, a character string, a numerical value, or a combination of at least two of these items for identifying a specific object from among a plurality of objects. The same applies to IDs other than the product ID.

TABLE 3

| | |
|---|---|
| Product Key | 0123-4567-8901 |

Table 3 indicates an example of a product key 3003. The product key 3003, which is distributed to the user when the user purchases the application, is license information for guaranteeing that the user is an authorized user. The product key 300 is referred to also as a license key or an authentication key.

In the activation server 50, for example, a set of a product ID and a product key of an application, which is a paid application and is distributed to the user by purchase, is registered.

Upon receiving the product ID and the product key transmitted from the electronic device 30, the activation server 50 checks whether a corresponding application has been activated. Note that the electronic device 30 does not store the product ID at all times, and it is sufficient for the electronic device 30 to have the product ID at the times of activation and deactivation.

TABLE 4

| Product ID | Activated |
|---|---|
| 001 | True |
| 002 | True |
| 003 | False |
| . . . | . . . |

Table 4 indicates an example of activation permission information 3004. The activation permission information 3004 indicates whether activation is permitted by the activation server 50, for each program. The activation permission information 3004 is stored in a secret place, which prevents third parties from copying the activation permission information 3004.

Alternatively, the activation permission information 3004 includes a hash value generated from information unique to the electronic device 30 in which the application is installed. The application is unable to boot up if the electronic device 30 fails to match the hash value.

In the activation permission information 3004, each product ID indicates whether the product ID is activated (True: completed) or not (False: incomplete). That is, each product ID is in association with “True” or “False”.

In the initial states, all of the product IDs indicate “False”. The electronic device 30A requests the activation server 50 to perform activation, in response to an instruction from the user.

Upon receiving a response from the activation server 50, the electronic device 30A sets the activation permission information 3004 in which a product ID of an installed application is in association with information indicating whether the application is activated (True) or not (False).

In this configuration, the electronic device 30A holds the activation result obtained from the activation server 50, which eliminates a need to inquire of the activation server 50 whether activation has been completed or not, at each time of booting up the application.

In the following, a description is given of the electronic device 30B. The electronic device 30B includes a communication unit 31, an operation acceptance unit 32, a display control unit 33, a setting data management unit 34, an activation request unit 36, and an application installing unit 37. The following further describes functional units of the electronic device 30B.

The activation request unit 36 requests the activation server 50 to activate the application. The activation request unit 36 is implemented by, for example, the CPU 21 of FIG. 3 executing a program.

The application install unit 37 installs the application acquired from the application server 60 in the electronic device 30, and further sets the setting data. The application install unit 37 is implemented by, for example, the CPU 21 of FIG. 3 executing a program.

The setting data 3001, the product ID 3002, and the product key 3003 are transmitted from the backup server 40, and stored in the storage unit 3000 of the electronic device 30 B.

The activation permission information 3004 is updated according to the result of activation and deactivation of the activation server 50.

The backup server 40 includes the communication unit 41, the setting data storage unit, and the setting data reading unit 43.

These functional units of the backup server 40 are implemented by operating any of the hardware elements illustrated in FIG. 4 under the control of the CPU 301 according to the application (program) expanded from the HDD 307 to the RAM 303. The program is distributed from a server for program distribution, or is distributed in a state where the program is stored in a storage medium.

Further, the communication unit 41 receives the setting data 3001, the product ID 3002, and the product key 3003 from the electronic device 30A, and transmits the setting data 3001, product ID 3002, and product key 3003 to the electronic device 30B. The communication unit 41 is implemented by, for example, the CPU in FIG. 4 executing a program to control the communication I/F 304.

The setting data storage unit 42 stores the setting data 3001, product ID 3002, and product key 3003, which have been transmitted from the electronic device 30A, in the setting data DB 4001 of the storage unit 3000. The setting data storage unit 42 is implemented by, for example, the CPU 301 in FIG. 4 executing a program.

The setting data reading unit 43 reads the setting data 3001, product ID 3002, and product key 3003 from the setting data DB 4001. The setting data reading unit 43 is implemented by, for example, the CPU 301 in FIG. 4 executing a program.

The backup server 40 includes a storage unit 4000. The storage unit 4000 is implemented using one or more of the HDD 307, RAM 303, and ROM 302 in FIG. 4. The storage unit 4000 stores setting data DB 4001.

TABLE 5

| Setting Data | Product ID | Product Key | Device ID |
|---|---|---|---|
| Setting Data 01 | 001 | 0123-4567-8901 | M1001 |
| Setting Data 02 | 001 | 1111-2222-3333 | M2001 |
| . . . | . . . | . . . | . . . |

Table 5 indicates information stored in the setting data DB 4001. In the setting data DB 4001, the setting data, product ID, product key, and device ID are stored in association with each other. The setting data, which is in association with the product ID and product key, pertains to an application. Alternatively, setting data that does not pertain to an application is stored in the setting data DB 4001.

The device ID is identification information for identifying the electronic device 30A before update.

The device ID is specified when importing the setting data, product ID, and product key to the electronic device 30B. With the electronic ID, the electronic device 30A, to which the setting data is transmitted, is identified. This configuration allows the CE 9 to import the corresponding application out of a plurality of applications stored in the backup server 40, by preliminarily making a note of or storing the device ID of the electronic device 30A.

As described above, the setting data, the product ID, and the product key, which are associated each other, are stored in the backup server 40. This configuration allows the CE 9 to import the setting data, the product ID, and the product key to the new electronic device 30B.

The activation server 50 includes a communication unit 51, an activation unit 52, and a deactivation unit 53. These functional units of the activation server 50 are implemented by operating any of the hardware elements illustrated in FIG. 4 under the control of the CPU 301 according to the application (program) expanded from the HDD 307 to the RAM 303.

The program is distributed from a server for program distribution, or is distributed in a state where the program is stored in a storage medium.

The communication unit 51 receives an activation request or a deactivation request from the electronic device 30, and transmits an activation permission or an activation non-permission. The communication unit 41 is implemented by, for example, the CPU in FIG. 4 executing a program to control the communication I/F 304.

Upon receiving an activation request from the electronic device 30B, the activation unit 52 determines whether to permit activation or not. When determining that activation is permitted, the activation unit 52 registers information indicating that the activation is completed in the product management DB 5001 of the storage unit 5000. The activation unit 52 is implemented by, for example, the CPU 301 of FIG. 4 executing a program.

Upon receiving a deactivation request from the electronic device 30A, the deactivation unit 53 determines whether to permit deactivation or not. When determining that deactivation is permitted, the deactivation unit 53 registers information indicating that the deactivation is completed in the product management DB 5001 of the storage unit 5000. The deactivation unit 53 is implemented by, for example, the CPU 301 of FIG. 4 executing a program.

The activation server 50 further includes the storage unit 5000. The storage unit 5000 is implemented using one or more of the HDD 307, RAM 303, and ROM 302 in FIG. 4. A product management DB 5001 is stored in the storage unit 5000.

TABLE 6

| | | Number | Licensed | Maximum | |
|---|---|---|---|---|---|
| Product | | of Used | Device | Number of | User |
| ID | Product Key | Licenses | ID | Licenses | ID |
| 001 | 0123-4567-8901 | 5 | M1001, . . . , | 10 | User |
| | | | M1005 | | A |
| 001 | 1111-2222-3333 | 1 | M2001 | 5 | User |
| | | | | | B |
| 002 | 8888-9999-0000 | 19 | M1001, . . . , | 20 | User |
| | | | M1019 | | A |
| . . . | . . . | . . . | . . . | . . . | . . . |

Table 6 indicates information stored in the product management DB 5001. In the product management DB 5001, the product ID, the product key, the number of used licenses, the licensed device ID, the maximum number of licenses, and the user ID are registered. The “maximum number of licenses” refers to the number of licenses (that is, the number of electronic devices 30) that allow activation to be performed with one product key, which is preset. The “number of used licenses” refers to the number of electronic devices 30 that have activated the same application. The “licensed device ID” refers to a list of device IDs of the electronic devices 30 that have activated the application. The “user ID” refers to identification information for identifying the customer.

As described above, the number of electronic devices 30 that are allowed to be activated is predetermined for each product ID. This prevents the user to use more electronic devices 30 than such a predetermined number to execute the application with one product.

In the following, a description is given of processing of information registered in the product management DB 5001. First, the storage unit 5000 registers the product ID, the product key, and the “maximum number of licenses” in the product management DB 5001 according to the predetermined purchase procedure by the user. The activation server 50 determines whether the product ID and product key transmitted from the electronic device 30 and stored in the product management DB 5001 are associated with each other, based on the product management DB 5001. When determining that the product ID and product key are associated with each other, the activation server 50 identifies the product key input by the user as the authorized key. When determining that the product ID and product key are not associated with each other, the activation server 50 identifies the product key input by the user, as an unauthorized key, and subsequently transmits information indicating the activation failure to the electronic device 30.

When the product key is identified as the authorized key, the activation server 50 further determines whether the transmitted device ID is registered as the licensed device ID in the product management DB 5001. When the device ID is registered as the licensed device ID in the product management DB 5001, the activation server 50 notifies the electronic device 30 of success of activation. When the device ID is not registered as the licensed device ID in the product management DB 5001, the activation server 50 determines whether the number of used licenses has achieved the maximum number of licenses. When the number of used licenses has not achieved the maximum number of licenses, the activation server 50 increments the number of used licenses by one, and registers the transmitted device ID as the licensed device ID. Subsequently, the activation server 50 transmits information indicating success of activation to the electronic device 30. When the number of used licenses has achieved the maximum number of licenses, the activation server 50 transmits information indicating failure of activation and excess of the number of licenses to the electronic device 30.

The application server 60 includes a communication unit 61 and an application provider 62. These functional units of the application server 60 are implemented by operating any of the hardware elements illustrated in FIG. 4 under the control of the CPU 301 according to the application (program) expanded from the HDD 307 to the RAM 303. The program is distributed from a server for program distribution, or is distributed in a state where the program is stored in a storage medium.

The communication unit 61 receives an application request from the electronic device 30B and transmits the requested application. The communication unit 61 is implemented by, for example, the CPU in FIG. 4 executing a program to control the communication I/F 304.

The application provider 62 reads, from an application DB 6001, the application requested by the product ID transmitted from the electronic device 30B. The application provider 62 is implemented by, for example, the CPU 301 of FIG. 4 executing a program.

The application server 60 includes a storage unit 6000. The storage unit 6000 is implemented using one or more of the HDD 307, RAM 303, and ROM 302 in FIG. 4. The storage unit 6000 stores application DB 6001.

TABLE 7

| | | Adaptation |
|---|---|---|
| Product ID | Application Name | Information |
| 001 | Copy Application | Any Type of Model |
| 002 | Print Application | Any Type of Model |
| 003 | Scan Application | Any Type of Model |
| 004 | OCR Application | Any Type of Model |
| 005 | ID Card Application | Adaptive to 1A23 |
| 006 | Various-Sizes Application | Adaptive to 2B34 |
| 007 | Translation Application | Ver. 1.0: |
| | | any type of model |
| | | Ver. 2.0: |
| | | adaptive to 3C45 |
| . . . | . . . | . . . |

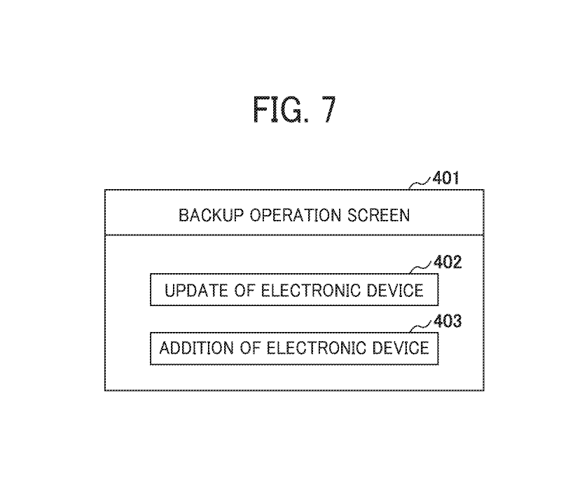

Table 7 indicates information stored in the application DB 6001. In the application DB 6001, a product ID, an application name, and adaptation information are registered. The product ID is identification information for identifying the application as described above. The application name is the name of the application used for designation or representation of the application. In some examples, the application name, which is used for describing the application, is not registered in the application DB 6001. The adaptation information pertains to the model of the electronic device 30 that allows the application to be installed therein. In the example of FIG. 7, the copy application, print application, scan application, and optical character recognition (OCR) application are adaptive to any type of model while the ID card application and various-sizes application are adapted to the electronic device 30 of a particular type of model. Further, a translation application is adaptive to a type of model that differs depending on the version of the translation application. The adaptation information is used to determine whether any application to be installed is adaptive to the electronic device 30B at the time of installation. This prevents an application that is unable to operate in the electronic device 30B to be installed in the electronic device 30B.

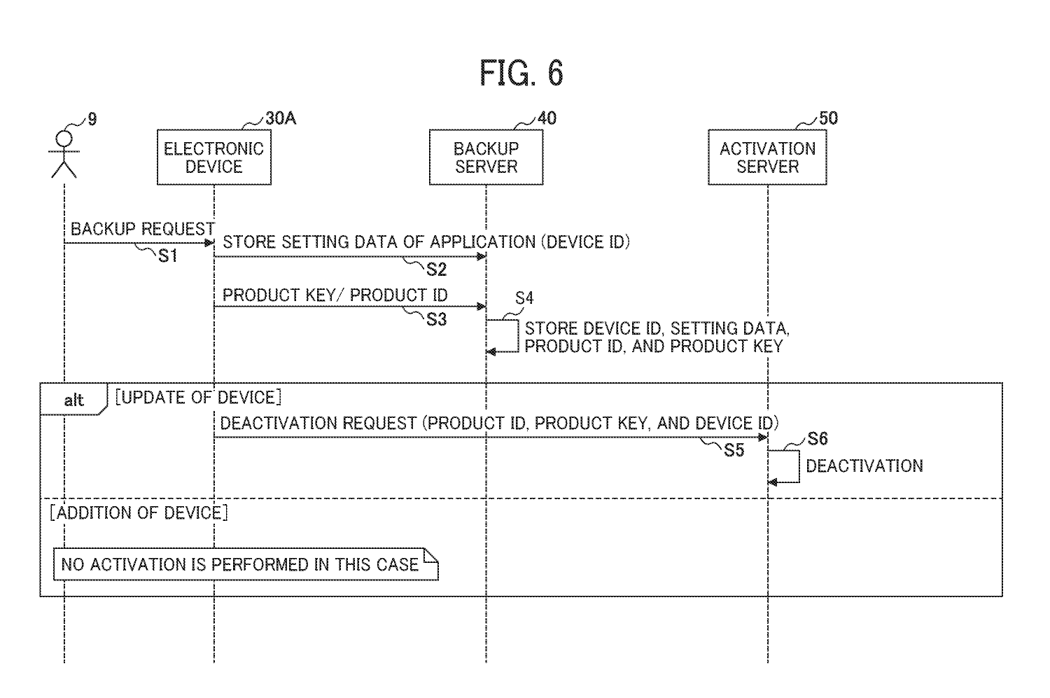

FIG. 6 is a sequence diagram of a process for storing setting data of the application in the backup server 40, performed by the program setting system of FIG. 1, according to an embodiment of the present disclosure. In the following, a description of the process is given referring to the backup operation screen in FIG. 7 as appropriate. Note that the CE 9 logs in to the backup server 40 and the activation server 50 as appropriate.

In step S1, in updating or adding the electronic device 30, the CE 9 operates the electronic device 30A to store setting data of the application in the backup server 40. As illustrated in FIG. 7, such an operation has two modes: updating the electronic device 30 and adding the electronic device 30. The CE 9 manually operates the operation panel 27. Alternatively, the CE9 transmits the signal corresponding to the manual operation from a personal computer (PC), which is connected to the electronic device 30A, to the electronic device 30A.

With this setting, the deactivation request unit 35 determines whether or not to deactivate the application to be backed up.

Note that the user presets an application to be backed up. In a case where any application is not to be backed up, the setting value can be backed up. Table 8 indicates setting data to be backed up in the backup server 40 in detail.

In step S2, the operation acceptance unit 32 of the electronic device 30A accepts an operation of the CE9. In response to the operation accepted by the operation acceptance unit 32, the setting data management unit 34 reads setting data 3001 from the storage unit 3000, and transmits the setting data 3001 together with the device ID to the backup server 40 via the communication unit 31.

In step S3, the setting data management unit 34 transmits the product ID and product key to the backup server 40 via the communication unit 31, in response to the operation of the CE9. Note that steps S2 and S3 are described as separate two processes, but these are executed as a series of processes.

In step S4, the communication unit 41 of the backup server 40 receives the device ID, the setting data, the product ID and the product key, and the setting data storage unit 42 stores the received device ID, setting data, product ID and product key in association with each other, in the setting data DB 4001.

The process of step S5 is executed when the mode for updating the electronic device 30 is selected on the backup operation screen. In step S5, the deactivation request unit 35 transmits a deactivation request to the activation server 50 via the communication unit 31.

The deactivation request includes the product ID, product key, and device ID. The deactivation request is made for all applications.

With the product ID and product key, an application to be deactivated is identified, and the corresponding device ID is deleted from the licensed device IDs.

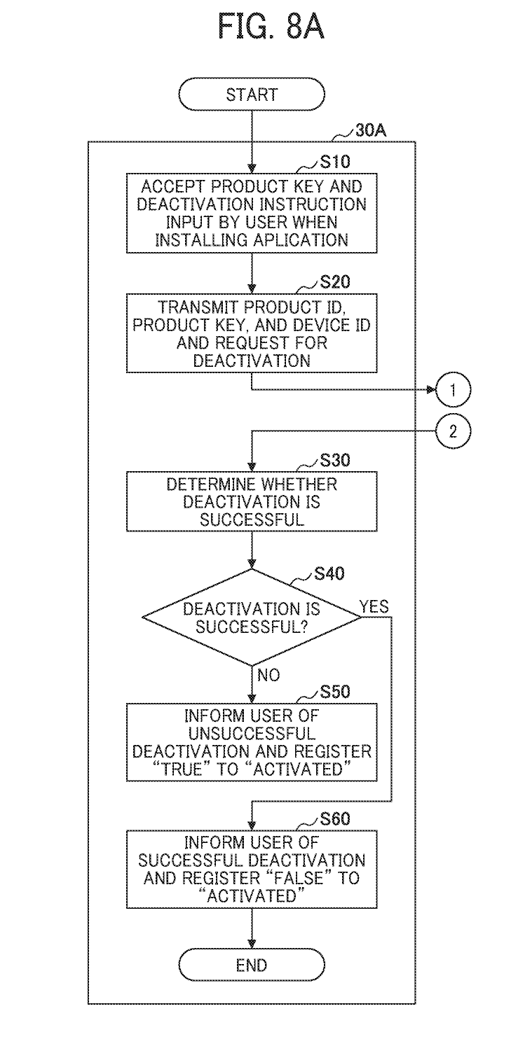

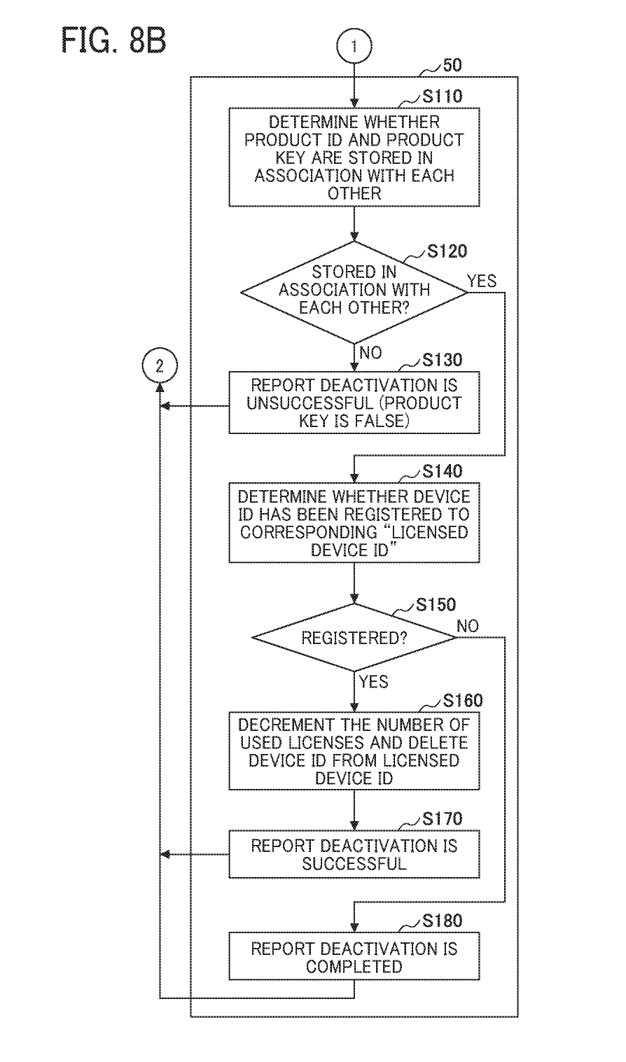

In step S6, the communication unit 51 of the activation server 50 receives the deactivation request, and the deactivation unit 53 performs a process for deactivation. A detailed description is given of the deactivation process, performed by the activation server 50 referring to FIG. 8.

In a case where the electronic device 30A is updated to the electronic device 30B, the application has to be deactivated in the electronic device 30A to allow the CE9 to successfully activate the application in the electronic device 30B. Deactivating the application in the electronic device 30A allows the application to be activated in the electronic device 30B.

TABLE 8

| Preference | | | | | Setting |
|---|---|---|---|---|---|
| ID | Secret | Unique | Binary | Item | Value |
| 10500002 | 0 | 0 | 0 | Additional | Character |
| | | | | Application | String in |
| | | | | | JSON Form |
| 10300015 | 0 | 0 | 0 | JavaScript | ON |
| | | | | (valid/invalid | |
| | | | | of registered | |
| | | | | trademark | |
| 10000001 | 1 | 0 | 0 | Wi-Fi (registered | FALSE |
| | | | | trademark) setting | |

Table 8 indicates setting data to be backed up in the backup server 40 in detail. The setting data includes items of preference ID, secret, unique, binary, item name, and setting value.

The first three letters of the preference ID are unique values assigned to each application. The last five digits are any numeric values that can be set for each application.

The preference ID allows the setting items of the application to be identified. The secret indicates whether or not confidential information such as a password is included. The unique indicates whether or not the data unique to the device is included.

The binary indicates whether or not the setting item data is binary data. The item name indicates the name of the setting item of the setting data for each application. The setting value is the data to be actually backed up.

At the time of backup, the setting data management unit 34 collects these pieces of information from each application and aggregates them in one comma separated value (CSV) file. At the time of import, the setting data management unit 34 refers to the CSV file and acquires the setting value to be reflected in each application based on the preference ID.

As indicated in Table 5, the backup server 40 manages this CSV file as backup data for each electronic device 30 by storing the CSV file for each device ID.

In Table 8 as an example, the preference ID of 10300015 is setting data stored by the browser application, that is, setting valid or invalid of Java Script (registered trademark). The preference ID of 10000001 is the setting data of the operation unit 20, that is, the setting of Wi-Fi. The preference ID of 10500002 is backed up information of the application.

The information of the application in JSON format is listed below for reference:

[{“Package Name”: “Sample Package 1”, “Product Id”: 12345678, “Product Key”: “ABCDEFGHIJKLMN”},

{“Package Name”: “Sample Package 2”, “Product Id”: 87654321, “Product Key”: “NMLKJIHGFEDCBA”}].

The “Package Name is a name unique to the application, and “Product Id” is the above-described product ID that is a number allocated to each application. The “Product Key” is the above-described product key.

FIG. 7 is an illustration of an example of the backup operation screen 401 according to an embodiment of the present disclosure. The backup operation screen 401 includes an update button 402 and an addition button 403 of the electronic device 30. When updating the electronic device 30A to the electronic device 30B, the CE 9 presses the update button 402 of the electronic device 30.

When the user sets the same setting data as that of the electronic device 30A in the newly purchased (added) electronic device 30 while continuing to use the electronic device 30A, the CE 9 presses the add button 403 of the electronic device 30. With such a user interface, the CE 9 switches whether or not to deactivate the application.

A set of FIGS. 8A and 8B is a flowchart of a deactivation process performed by the electronic device 30A and the activation server 50. FIG. 8A is a flowchart of processes performed by the electronic device 30A. FIG. 8B is a flowchart of processes performed by the activation server 50.

The user first selects an application and inputs a product key, requesting the electronic device 30A to deactivate the application (make a deactivation request). The operation acceptance unit 32 of the electronic device 30A accepts the operations inputs by the user (step S10).

The deactivation request unit 35 of the electronic device 30A transmits the product ID, product key, device ID, and the deactivation request to the activation server 50 (step S20). In this case, the product ID is automatically determined by the selected application.

The communication unit 51 of the activation server 50 receives the deactivation request. The deactivation request includes the product ID, product key, and device ID.

The deactivation unit 53 determines whether or not the product ID and the product key for the device ID are stored in association with each other in the product management DB 5001 (step S110).

At the time of deactivation, the product ID and the product key are registered in the product management DB 5001. Usually, the product key is secret and accordingly the third party having only the product ID is unable to deactivate the application.

When a negative determination is made in step S120 (No in step S120), the activation unit 52 transmits an error message to the electronic device 30B (step S130). For example, such an error message indicates “the product ID and product key are not registered.”.

When an affirmative determination is made in step S120 (Yes in step S120), the deactivation unit 53 determines whether or not the device ID has been registered in the “licensed device ID” (step S140).

When a negative determination is made in step S150 (No in step S150), the deactivation unit 53 transmits an error message indicating that the deactivation is completed to the electronic device 30A (step S180). In this case, such an error message indicates “deactivation ends in error”.

When an affirmative determination is made in step S150 (Yes in step S150), the deactivation unit 53 decrements (deletes) the number of used licenses by one, and deletes the device ID from the list of the licensed device ID (step S160).

Subsequently, the deactivation unit 53 reports success in deactivation to the electronic device 30B (step S170). When the device ID transmitted from the electronic device 30A is registered in the list of the licensed device IDs, the number of used licenses is assumed to be more than one. If the number of used licenses is zero, the deactivation unit 53 transmits an error message to the electronic device 30A.

The communication unit 31 of the electronic device 30A receives deactivation success or failure from the activation server 50. The deactivation request unit 35 of the electronic device 30A determines whether deactivation is successful or not (step S30).

When a negative determination is made in step S40 (deactivation has failed), the display control unit 33 displays the deactivation failure on the operation panel 27 (step S50). In this case, the column of “activated” remains “True” in the activation permission information 3004 in Table 4.

When an affirmative determination is made (Yes in step S40: deactivation is successfully completed), the display control unit 33 displays the deactivation success on the operation panel 27, and registers “False” in the activation permission information 3004 in Table 4 (step S60).

With the application deactivated in the electronic device 30A, the electronic device 30B becomes ready to activate the application.

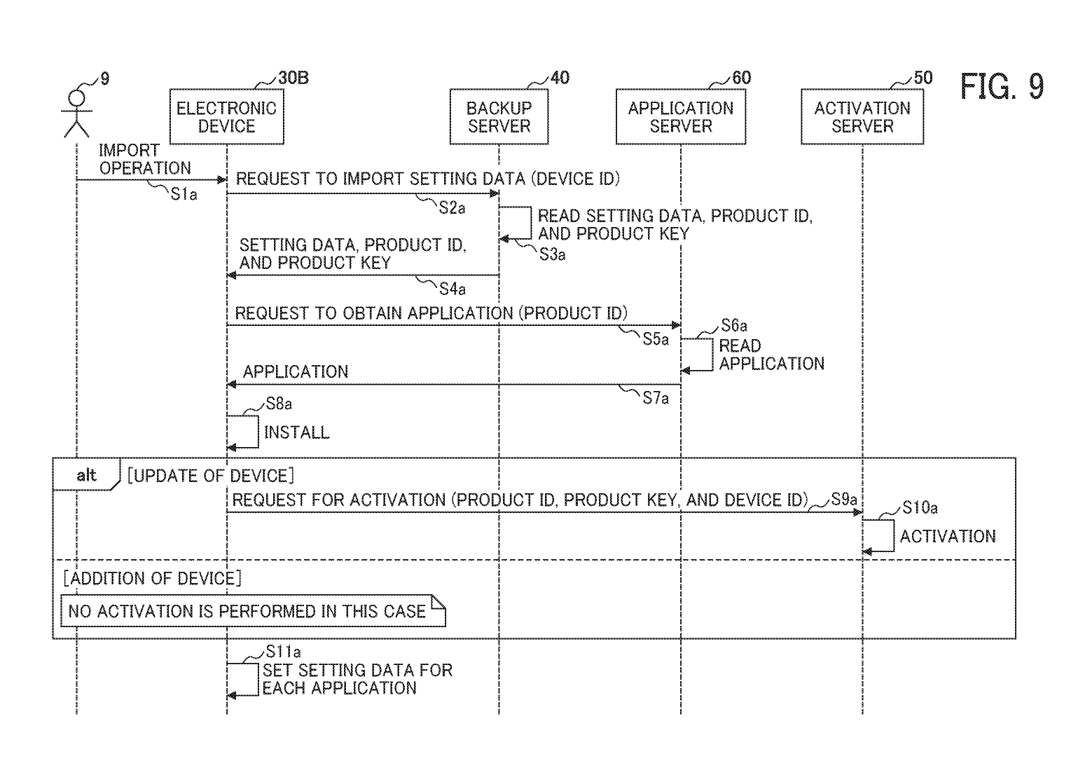

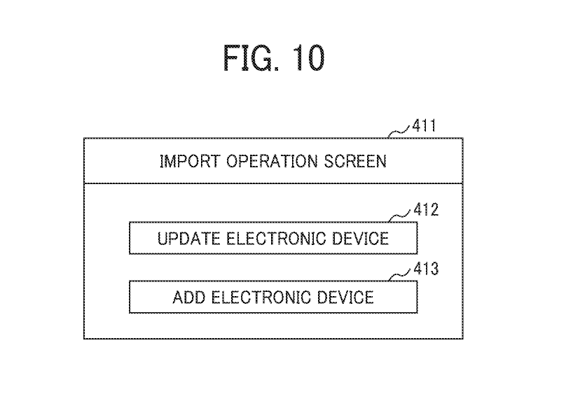

FIG. 9 is a sequence diagram of an example of a process for importing setting data of an application to the electronic device 30B, performed by the CE9. In the following, a description of the process is given referring to the import operation screen in FIG. 10 as appropriate. Note that the CE 9 logs in to the backup server 40, the activation server 50, and the application server 60 as appropriate.

In step S1a, the CE9 operates the electronic device 30B to import setting data of the application from the backup server 40 to the electronic device 30B.

As illustrated in FIG. 10, such an operation has two modes: a mode for updating the electronic device 30 and a mode for adding the electronic device 30. The CE 9 manually operates the operation panel 27. Alternatively, the CE9 transmits the signal corresponding to the manual operation from a PC, which is connected to the electronic device 30B, to the electronic device 30B. Such an operation determines whether to activate the installed application.

In step S2a, the operation acceptance unit 32 of the electronic device 30B accepts the operation of the CE 9. Upon accepting the operation of the CE 9, the setting data management unit 34 transmits a request for importing setting data to the backup server 40 via the communication unit 31.

The request for importing setting data includes the device ID of the electronic device 30A. The device ID of the electronic device 30A may be input by the CE 9, who may be previously informed of the device ID. Alternatively, the electronic device 30A preliminarily transmits the device ID of the electronic device 30A to the electronic device 30B.

In step S3a, the communication unit 41 of the backup server 40 receives the request for importing setting data that includes the device ID of the electronic device 30A, and the setting data reading unit 43 reads the setting data, the product ID and the product key associated with the device ID from the setting data DB 4001.

In step S4a, the communication unit 41 of the backup server 40 transmits the setting data, product ID, and product key to the electronic device 30B.

In step S5a, the communication unit 31 of the electronic device 30B receives the setting data, product ID, and product key. Upon such a reception of the communication unit 31, the application install unit 37 transmits the product ID together with a request for obtaining the application (application request) to the application server 60.

In step S6a, the communication unit 61 of the application server 60 receives the application request, and the application provider 62 of the application server 60 reads an application identified by the product ID, from the application DB 6001.

In step S7a, the communication unit 61 of the application server 60 transmits the application identified by the product ID to the electronic device 30B.

In step S8a, the communication unit 31 of the electronic device 30B receives the application from the application server 60. Accordingly, the application install unit 37 installs the application in the electronic device 30B.

In some examples, the application is read out from a portable storage medium and installed in the electronic device 30B.

The following processes of steps S9a and 10a are executed when the mode for updating the electronic device 30 is selected on the backup operation screen.

In step S9a, the activation request unit 36 transmits an activation request to the activation server 50 via the communication unit 31.

The activation request includes the product ID, product key, and device ID.

The activation server 50 determines whether the product ID and the product key are licensed for the application (authenticated). The electronic device 30B registers the device ID in the lists of “licensed device IDs” of the activation permission information 3004 depending on the determination result of the activation server 50.

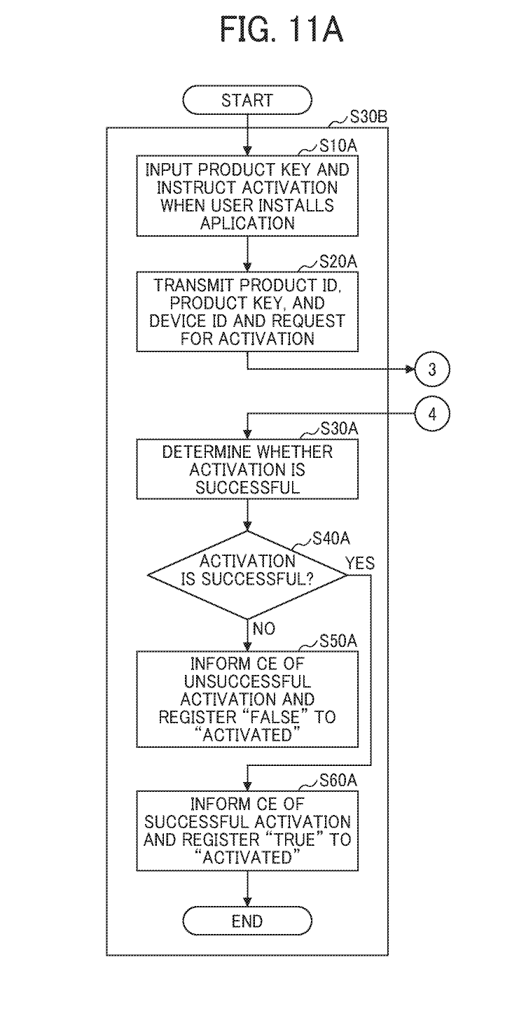

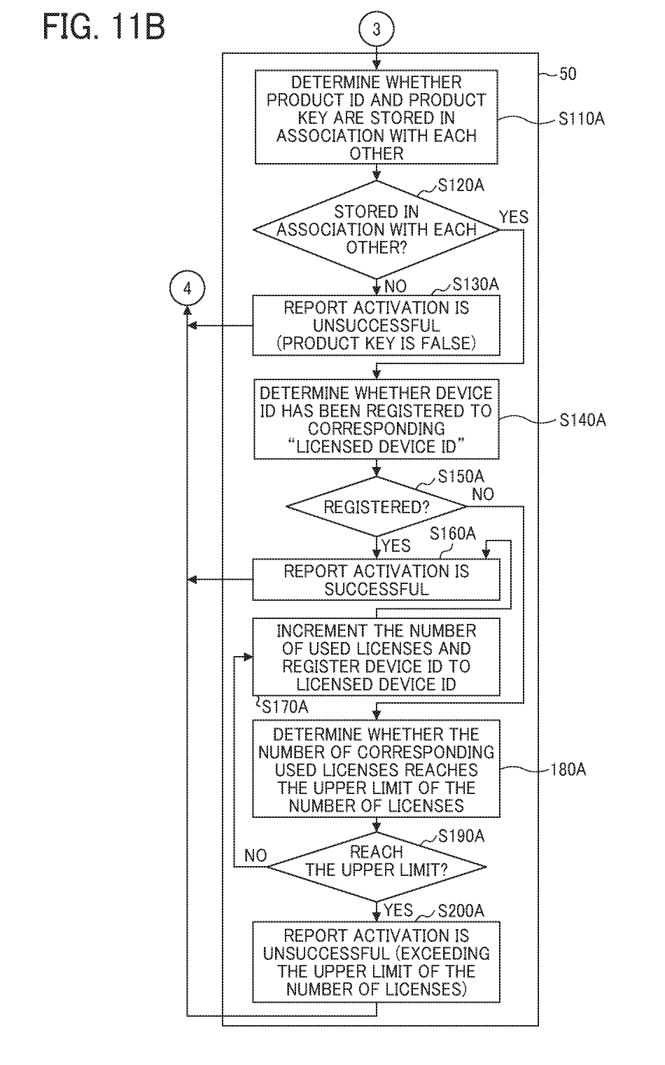

In step S10a, the communication unit 51 of the activation server 50 receives an activation request, and subsequently the activation unit 52 performs a process for activation. A detailed description is given later of the activation process, performed by the activation server 50 referring to FIG. 11.

In step S11a, the setting data management unit 34 sets setting data to the application when the application is completely activated.

Accordingly, the application formerly operated in the electronic device 30A is installed in the electronic device 30B, and the setting data of the electronic device 30A is set to the application.

The export request and the import request are independently issued. Accordingly, the user might select the mode for adding an electronic device 30 without performing deactivation, in issuing the export request. In issuing the import request, the user selects the mode for updating the device, which involves performing activation. Alternatively, the user might select the mode for updating an electronic device 30 in issuing the export request, and selects the mode for adding the device in issuing the import request.

In those cases, the activation might result in failure at the time of import.

To avoid such circumstances, the electronic device 30B transmits the backed-up setting data with information indicating setting data for updating the electronic device 30 or setting data for adding an electronic device 30 attached, to the backup server 40. The electronic device 30B, which is an import source, determines whether the update or addition setting by the user is correct or not.

When the mode for adding an electronic device 30 is selected in issuing the export request, the activation request unit 36 of the electronic device 30B refuses to accept the selection of the mode for updating the device in issuing the import request.

In the opposite case at which the mode for updating the device is selected in issuing the export request, the activation request unit 36 of the electronic device 30B refuses to accept the selection of the mode for adding the device in issuing the import request.

Depending on the mode for updating the electronic device 30 or the mode for adding the electronic device 30 selected in the electronic device 30A, the activation request unit 36 of the electronic device 30B refuses to accept the selection of the mode for updating the device or the mode for adding the device.

With such a configuration, inconsistency of settings at the time of exporting and importing is prevented.

FIG. 10 is an illustration of an example import operation screen 411. The import operation screen 411 includes an update button 412 and an electronic device addition button 413 of the electronic device 30. When updating the electronic device 30A to the electronic device 30B, the CE 9 presses the update button 402 of the electronic device 30.

When the user sets the same setting data as that of the electronic device 30A in the newly purchased (added) electronic device 30 while continuing to use the electronic device 30A, the CE 9 presses the add button 413 of the electronic device 30. With such a user interface, the CE 9 switches whether or not to activate the application.

A set of FIGS. 11A and 11B is a flowchart of an activation process performed by the electronic device 30A and the activation server 50. FIG. 11A is a flowchart of processes performed by the electronic device 30A. FIG. 11B is a flowchart of processes performed by the activation server 50.

First, when installing an application, the user inputs a product key and instructs activation to make an activation request. The operation acceptance unit 32 of the electronic device 30B accepts the operations inputs by the user (step S10A).

The activation request unit 36 of the electronic device 30B transmits the product ID, product key, device ID, and the deactivation request to the activation server 50 (step S20A).

In this case, the product ID is automatically determined by the application to be installed.

The communication unit 51 of the activation server 50 receives the activation request. The activation request includes the product ID, product key, and device ID.

The activation unit 52 determines whether or not the product ID and the product key for the device ID are stored in association with each other in the product management DB 5001 (step S110A).

The product ID and the product key are registered in the product management DB 5001, for example, when the user purchases the application.

When a negative determination is made in step S120A (No in step S120A), the activation unit 52 transmits an error message to the electronic device 30B (step S130A).

For example, the activation unit 52 transmits such an error message indicating that “the product ID and product key are not registered.”

When an affirmative determination is made in step S120A (Yes in step S120A), the deactivation unit 53 determines whether or not the device ID has been registered in the “licensed device ID” (step S140A).

When an affirmative determination is made in step S150A (Yes in step S150A), the activation unit 52 transmits a message indicating the activation success to the electronic device 30B (step S160A) because there is no need to register the device.

When a negative determination is made in step S150A (No in step S150A), the activation unit 52 determines whether or not the number of used licenses has achieved the maximum number of licenses (step S180A).

When a negative determination is made in step S190A (No in step S190A), the activation unit 52 increments the number of used licenses by one, and registers the device ID in the list of the licensed device IDs (S170A). The activation unit 52 transmits a message indicating activation success to the electronic device 30B (S160A).

When an affirmative determination is made in step S190A (Yes in step S190A), the activation unit 52 transmits a message indicating the activation failure to the electronic device 30B (step S200A).

The communication unit 31 of the electronic device 30B receives activation success or failure from the activation server 50. The activation request unit 36 of the electronic device 30A determines whether activation is successful or not (step S30A).

When a negative determination is made in step S40A, the display control unit 33 displays the activation failure on the operation panel 27 (step S50A), and registers False in the activation permission information 3004. In such a configuration, the activation is not permitted in the electronic device 30B, which prevents the application to be executed in more electronic devices 30 than the maximum number of the electronic devices 30.

When an affirmative determination is made in step S40A, the display control unit 33 displays the activation success on the operation panel 27, and registers “True” in the activation permission information 3004 (step S60A).

The configuration that stores the product ID and product key in the backup server 40 as described above enables the electronic device 30B to install and activate the application without the electronic device 30A's storing the application in the backup server 40.

The cases where the electronic device 30B installs the application are described in the sequence diagram of FIG. 9. However, in some cases, some applications are unable to be installed depending on the combination of the electronic device 30 and the application.

For example, when the application is old and the electronic device 30 is new in version, or when the application is new and the electronic device 30 is old, there are cases in which the electronic device 30B is unable to execute the application.

To avoid such circumstances, the electronic device 30B determines whether installation is permitted or not before installing the application.

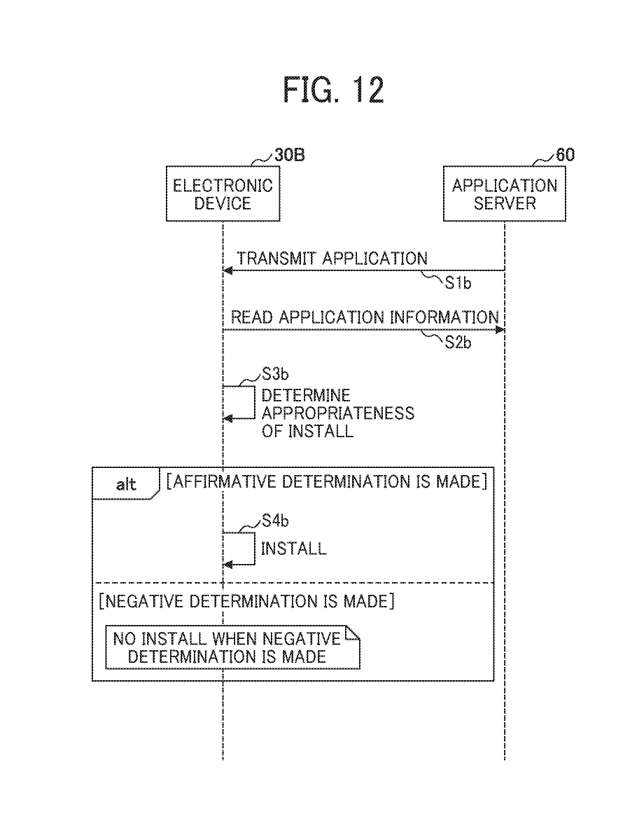

FIG. 12 is a sequence diagram of a process for installing the application, performed by the electronic device 30B.

In step S1b: As described above, the communication unit 31 of the electronic device 30B receives the application identified by the product ID.

In step S2b: The communication unit 31 of the electronic device 30B also receives the adaptation information of the received application.

In step S3b: The application install unit 37 of the electronic device 30B determines the validity of the installation by referring to the adaptation information. That is, the electronic device 30B determines whether the application adapts to the model type of the electronic device 30B when the adaptation information indicates that the application adapts only to the specific type of electronic device 30. Further, the electronic device 30B determines whether the model of the electronic device 30B is compatible with the version of the acquired application when the adaptation information indicates that the model compatible with the application differs with the version of the application.

In step S4b: When determining that installation is valid, the application install unit 37 installs the application.

When determining that installation is not valid, the application install unit 37 does not install the application. In this case, the electronic device 30B displays the application that is unable to be installed, on the operation panel 27, stores the log, and prints the application.

In such a configuration, the electronic device 30B checks the adaptation information of the application to install the application that is guaranteed to operate.

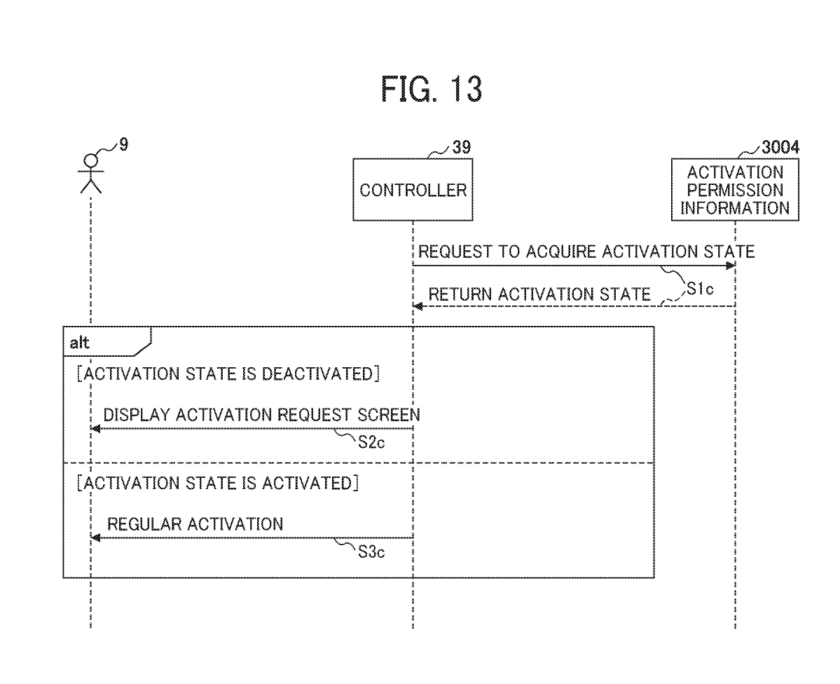

FIG. 13 is a flowchart of a process for determining whether the application is activated according to the presence or absence of activation.

In step S1c: The user operates the electronic device 30 to boot the application. The operation acceptance unit 32 of the electronic device 30 accepts an application execution request.

The control unit 39 of the electronic device 30 reads the activation status of the application whose booting operation has been performed, from the activation permission information 3004 of the storage unit 3000.

In step S2c: When the column of “activated” is “True”, the control unit 39 controls the display control unit 33 to display the activation request screen.

This allows the user to know the necessity of activation.

In step S3c, when the column of “activated” is “False”, the control unit 39 boots the application.

In some examples, the electronic device 30A displays a message indicating that activation has not been performed, on the operation panel 27.

In such a configuration, the application changes the behavior with the activation status. Note that, for example, the administrator sets the behavior of the application for each application, as desired.

For example, even if “activated” is “False”, booting may be permitted, or booting may be permitted only for a certain number of times.

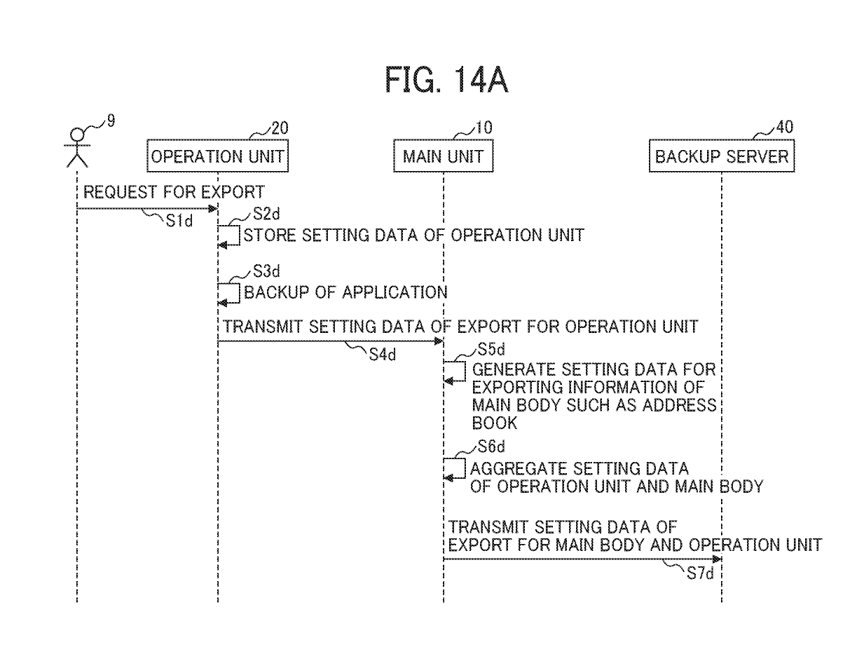

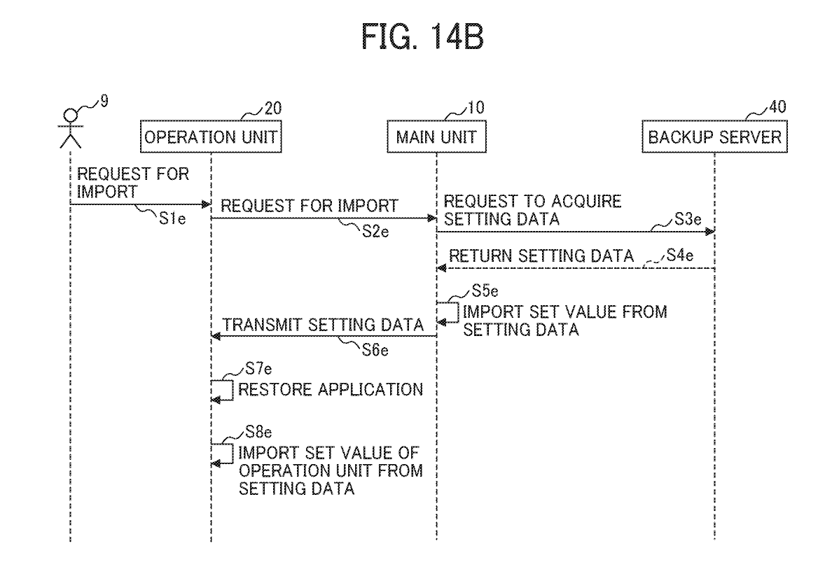

FIG. 14A is a sequence diagram of a process for exporting setting data according to an embodiment of the present disclosure. Referring to FIG. 14A, the cases where the operation unit 20 operates the application are described below.

In step S1d: The CE 9 inputs an export operation to the electronic device 30A.

In step S2d: The operation unit 20 of the electronic device 30A accepts the operation of the CE9 and stores the setting data.

In step S3d: The operation unit 20 of the electronic device 30A creates setting data of the application.

In step S4d: The operation unit 20 of the electronic device 30A transmits the setting data of the application for export, to the main unit 10.

In step S5d: The main unit 10 of the electronic device 30A creates setting data of the main unit 10 for export such as an address book.

In step S6d: The main unit 10 of the electronic device 30A combines the setting data of the operation unit 20 and the setting data of the main unit 10.

In step S7d: The main unit 10 of the electronic device 30A transmits the aggregated setting data (including the product ID and the product key) and the device ID to the backup server 40.

FIG. 14B is a sequence diagram of a process for importing setting data according to an embodiment of the present disclosure.

In step S1e: The CE 9 inputs an import operation to the electronic device 30B.

In step S2e: The operation unit 20 of the electronic device 30B transmits an import request to the main unit 10.

In step S3e: The main unit 10 of the electronic device 30B transmits the acquisition request of the setting data together with the device ID to the backup server 40.

In step S4e: The setting data reading unit 43 of the backup server 40 reads the product ID, the product key, and the setting data associated with the device ID from the setting data DB 4001, and the communication unit 41 transmits the product ID, the product key, and the setting data to the main unit 10.

In step S5e: The main unit 10 of the electronic device 30B imports the setting data of the main unit 10.

In step S6e: The main unit 10 transmits the setting data to the operation unit 20.

In step S7e: The operation unit 20 restores the application to its original state. That is, the application is acquired from the application server 60 using the product ID and installed. Further, the application is activated using the product ID and product key.

In step S8e: The operation unit 20 of the electronic device 30B imports the setting data of the operation unit 20.

In the program setting system 100 according to the embodiments of the present disclosure, the updated electronic device 30B acquires an application from the application server 60 by backing up the product ID and product key without backing up the application at the time of updating the electronic device 30.

Using the mechanism of deactivation and activation, the user can use the application in the electronic device 30B.

Accordingly, such a configuration prevents use of a large volume of data for backing up the application while reducing a time required for backing up the application.

—Variations—

The present invention is not limited to the details of the example embodiments described above, and various variations and improvements are possible.

For example, in the above-described embodiments, the cases where deactivation and activation are executed are described, but deactivation and activation may not be executed.

For example, in the case where a booting method in which the electronic device 30 has to log in to a predetermined server at the time of booting the application, the server prohibits simultaneous login of the plurality of electronic devices 30. This can exhibit the same advantageous effects as those of activation and deactivation.

Therefore, instead of performing deactivation and activation at the time of updating the electronic device 30, authentication processing for each booting is performed.

As in the configuration example of the program setting system 100 in FIG. 2, the backup server 40, the activation server 50, and the application server 60 may exist independently or may be integrated as one or two servers.

Alternatively, one or more functions of the backup server 40, the activation server 50, and the application server 60 may be distributed among a plurality of servers.

In the configuration example of FIG. 5, the functions are categorized into the main functions in order to facilitate understanding of processing by the electronic device 30, the backup server 40, the activation server 50, and the application server 60.

No limitation is intended by how the processes are divided or by the name of the processes.

The processing of the electronic device 30, the backup server 40, the activation server 50, and the application server 60 can be further divided into processing units according to the processing contents.

Alternatively, one process may be divided to include a larger number of processes.

The information transmitting means is an example of the communication unit 31 of the electronic device 30 A, the information receiving means is an example of the communication unit 31 of the electronic device 30 B, and the application install unit 37 is an example of the installing means. The activation request unit 36 is an example of an activation request means, the display control unit 33 is an example of a display control means, and the operation acceptance unit 32 is an example of an operation acceptance means.

The backup operation screen 401 is an example of the first screen and the import operation screen 411 is an example of the second screen.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A program setting system comprising:
a first electronic device communicable with one or more servers including an application server; and
a second electronic device communicable with the one or more servers,
the first electronic device including first circuitry to transmit, to the one or more servers, identification information of the first electronic device and program identification information for identifying a program operating in the first electronic device,
the second electronic device including second circuitry to:
receive, from the one or more servers, the program identification information identified by the identification information of the first electronic device;
acquire the program identified by the program identification information from the application server; and
install the acquired program in the second electronic device.

2. The program setting system according to claim 1,
wherein the first circuitry is configured to:
transmit, with the program identification information, a deactivation request to deactivate the program to an activation server of the one or more servers; and
transmit license information regarding a right to use the program to the one or more servers,
wherein the second circuitry is configured to:
receive, from the one or more servers, the license information identified by the identification information of the first electronic device; and
transmit, to the activation server, the identification information of the program, the license information, and an activation request to activate the program.

3. The program setting system according to claim 2,
wherein the first circuitry is further configured to transmit, to the one or more servers, setting data regarding setting of the program, and
wherein the second circuitry is further configured to:
receive, from the one or more servers, the setting data identified by the identification information of the first electronic device; and
set the setting data to the program installed in the second electronic device.

4. The program setting system according to claim 2,
wherein the first electronic device further includes a first operation panel and a first network interface,
wherein the first circuitry is further configured to:
display, on the first operation panel, a first screen to receive a selection of one of an update of an electronic device and an addition of an electronic device;
accept the selection received at the first screen;
control a first network interface to transmit the deactivation request to the activation server in response to an acceptance of the selection of the update of the electronic device, and
control the first network interface not to transmit the deactivation request to the activation server in response to an acceptance of the selection of the addition of the electronic device.

5. The program setting system according to claim 4,
wherein the second electronic device further includes a second operation panel and a second network interface,
wherein the second circuitry is further configured to:
display, on the second operation panel, a second screen to receive a selection of one of an update of an electronic device and an addition of an electronic device;
accept the selection received at the second screen;
control the second network interface to transmit the activation request to the activation server in response to an acceptance of the selection of the update of the electronic device, and
control the second network interface not to transmit the activation request to the activation server in response to an acceptance of the selection of the addition of the electronic device.

6. The program setting system according to claim 5,
wherein the first circuitry is configured to transmit the selection received at the first screen to the one or more servers, and
wherein the second circuitry is configured to:
receive the selection transmitted by the first circuitry, from the one or more servers, and
refuse to accept the selection of one of the update of the electronic device and the addition of the electronic device in the second electronic device, depending on the selection received at the first screen of the first electronic device.

7. The program setting system according to claim 2,
wherein the one or more servers includes a display, and
wherein each of the first circuitry and the second circuitry is configured to:
store, for each one or more of a plurality of programs, activation permission information in association with the program, the activation permission information indicating whether the program is activated;
determine whether the program is activated based on the activation permission information in response to an acceptance of a request to boot the program;
boot the program in response to a determination that the program is activated; and
display a message indicating that the program is to be activated in response to a determination that the program is not activated.

8. The program setting system according to claim 1,
wherein the second circuitry is configured to:
acquire, from the one or more servers, adaptation information for installing the program identified by the program identification information in the second electronic device to acquire the program;
determine whether the second electronic device is adaptable to the adaptation information; and
install the acquired program in the second electronic device in response to a determination that the second electronic device is adaptable to the adaptation information.

9. A program setting method comprising:
receiving program identification information for identifying a program operated in a first electronic device, by a second electronic device, from one or more servers communicable with the first electronic device and the second electronic device, the program identification information having been transmitted from the first electronic device to the one or more servers with identification information of the first electronic device;
acquiring the program identified by the program identification information from an application server of the one or more servers; and
installing the identified program in the second electronic device.

10. The program setting method according to claim 9, further comprising:
receiving, from the one or more servers, license information regarding a right to use the program, the license information having been transmitted from the first electronic device with a deactivation request to deactivate the program; and
transmitting the program identification information, the license information, and an activation request to activate the program to an activation server of the one or more servers.

11. The program setting method according to claim 10, further comprising:
receiving setting data from the information processing device, the setting data having been transmitted from the first electronic device for storage in the one or more servers in association with the identification information of the first electronic device; and
setting the received setting data to the second electronic device.

12. The program setting method according to claim 10, further comprising:
displaying a screen on an operation panel of the second electronic device to receive a selection of one of an update of an electronic device an addition of an electronic device;
accepting the selection received at the screen;
wherein, when the accepting accepts the selection of the update of an electronic device, the method further comprising:
controlling a network interface of the second electronic device to transmit the activation request to the activation server,
wherein, when the accepting accepts the selection of the addition of the electronic device, the method further comprising:
controlling the network interface not to transmit the activation request to the activation server.

13. The program setting system according to claim 12, further comprising:
receiving a selection of one of an update of an electronic device and an addition of an electronic device performed by the first electronic device, from the one or more servers; and
refusing to accept the selection of one of the update of the electronic device and the addition of the electronic device, depending on the received selection.

14. The program setting method according to claim 10, further comprising:
storing activation permission information in association with each program, the activation permission information indicating whether the program is activated;
determining whether the program is activated based on the activation permission information in response to an acceptance of a request to boot the program;
booting the program in response to a determination that the program is activated; and
displaying a message indicating that the program is to be activated in response to a determination that the program is not activated.

15. The program setting method according to claim 9, further comprising:
acquiring, from the information processing device, adaptation information for installing the program identified by the program identification information to acquire the program;
determining whether the second electronic device is adaptable to the adaptation information; and
installing the acquired program in the second electronic device when the determining determines that the second electronic device is adaptable to the adaptation information.

16. An electronic device comprising circuitry to:
receive program identification information for identifying a program operated in another electronic device, by the electronic device, from one or more servers communicable with the electronic device and said another electronic device, the program identification information having been transmitted from said another electronic device to the one or more servers with identification information of said another electronic device;
acquire the program identified by the program identification information from an application server of the one or more servers; and
install the identified program in the electronic device.
